(19) United States
(12) Patent Application Publication
(10) Pub. No.: US 2008/0147449 A1
(43) Pub. Date: Jun. 19, 2008

(54) METHOD FOR INSURANCE PORTFOLIO ANALYSIS

(76) Inventor: Jerry N. Ward, Cordova, TN (US)

Correspondence Address: Susan B. Fentress;Suite 440, 6060 Poplar Avenue, Memphis, TN, 38119, US

(21) Appl. No.: 12/039,618

(22) Filed: Feb. 28, 2008

Related U.S. Application Data
(63) Continuation of application No. 11/269,356, filed on Nov. 8, 2005.

(51) Int. Cl. G06Q 40/00

(52) U.S. Cl. 705/4

(57) ABSTRACT

A method for insurance portfolio analysis is provided. More specifically, a web based system is disclosed for managing user sessions over the Internet. The user can provide data relating to present and proposed insurance policies and receive access to a summary and various comparison graphs.

### RELATED APPLICATIONS

This application is a continuation of U.S. Utility application Ser. No. 11/269,356 filed Nov. 8, 2005.

This application claims the benefit of U.S. Provisional Application Ser. No. 60/626,016 filed Nov. 8, 2004, under 35 U.S.C. § 119 (hereby specifically incorporated herein by reference in its entirety)

### FIELD OF THE INVENTION

The present invention relates, in general, to a method and system for insurance portfolio analysis.

### BACKGROUND OF THE INVENTION

Individuals purchase a variety of life insurance policy types. Some policies offer greater value, while others offer lower risk. For example, permanent insurance total death benefit is typically allocated between the insurer's net amount at risk and the policy holder's policy cash value. It is in the best interest of the policy holder to pay no more premium than is necessary to keep the policy in force while minimizing his/her portion at risk and to maximize the insurer net amount at risk. It is difficult to compare one policy to another as there are so many variables. Moreover, it is even more difficult to compare a group of policies held by a policy holder as a portfolio.

Therefore, a substantial need exists for a method and system which analyzes an insurance portfolio for various features; such as, to determine the cost of insurance based on a stated value of money, the annual rates of return, and the insurer's net amount at risk to the policy holder's beneficiary. To accomplish the above, a standard template for analyzing insurance policies must be used because an insurer's in-force ledgers vary in format for different type policies and often have varying formats for same types of policies that are of a different generation.

### SUMMARY OF THE INVENTION

The current invention provides a method for both individual policy and insurance portfolio analysis. This method includes the steps for processing data acquired from insurance company in-force policy ledgers of present policies to prepare individual insurance policy analysis reports that are consolidated to create an insurance portfolio analysis report of present policies with present policy options; processing data acquired from ledgers for the same present in-force policies (which incorporate proposed policy option changes) to prepare individual insurance policy analysis reports that are consolidated to create an insurance portfolio analysis report of present policies with proposed policy option changes. The new proposed insurance policy analysis is then consolidated with the present in-force policies (which may incorporate proposed policy option changes) to generate a proposed insurance portfolio analysis report. The proposed insurance portfolio analysis report is then integrated with the present insurance portfolio analysis report (with present policy options) to generate the insurance portfolio analysis summary which compares the present insurance portfolio (with present policy options) and the proposed insurance portfolio (present policies with proposed policy option changes and the proposed additional insurance). The financial data is summarized and presented in graphic format.

### DETAILED DESCRIPTION OF THE FIGURES

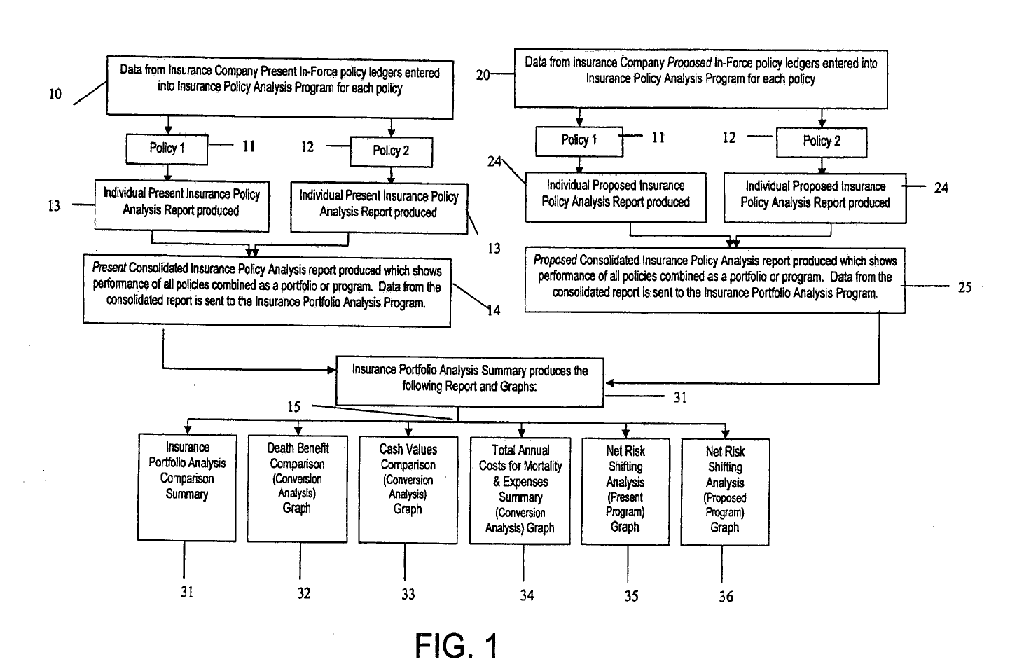

FIG. 1 is a flow chart of insurance portfolio analysis of present policies.

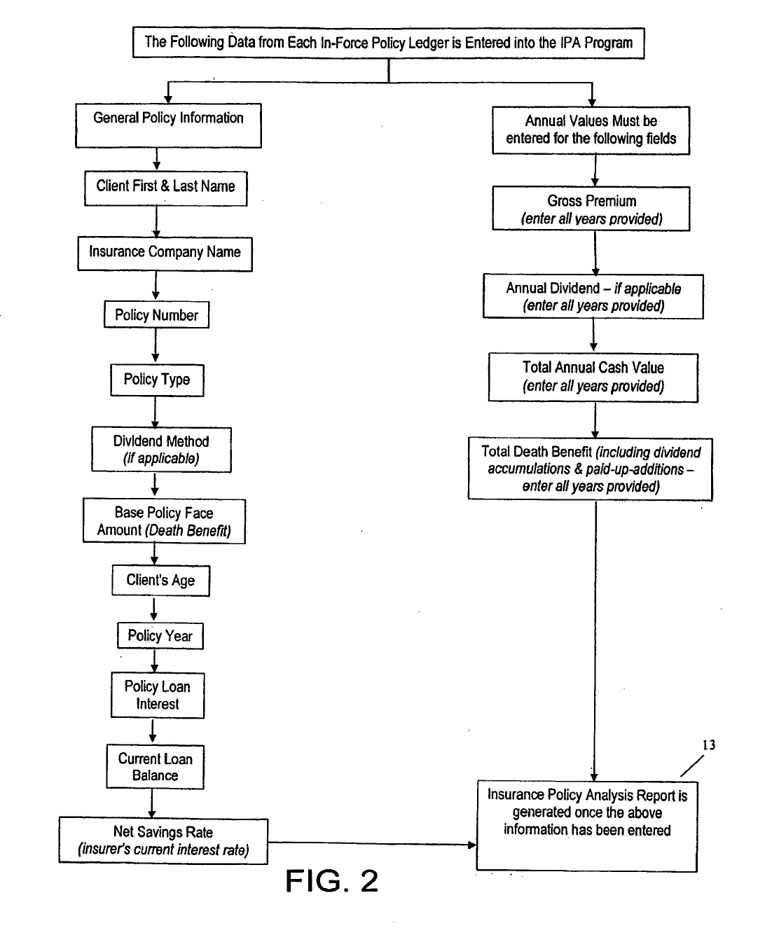

FIG. 2 is a flow chart of data entry detail to generate an insurance policy analysis report for each policy.

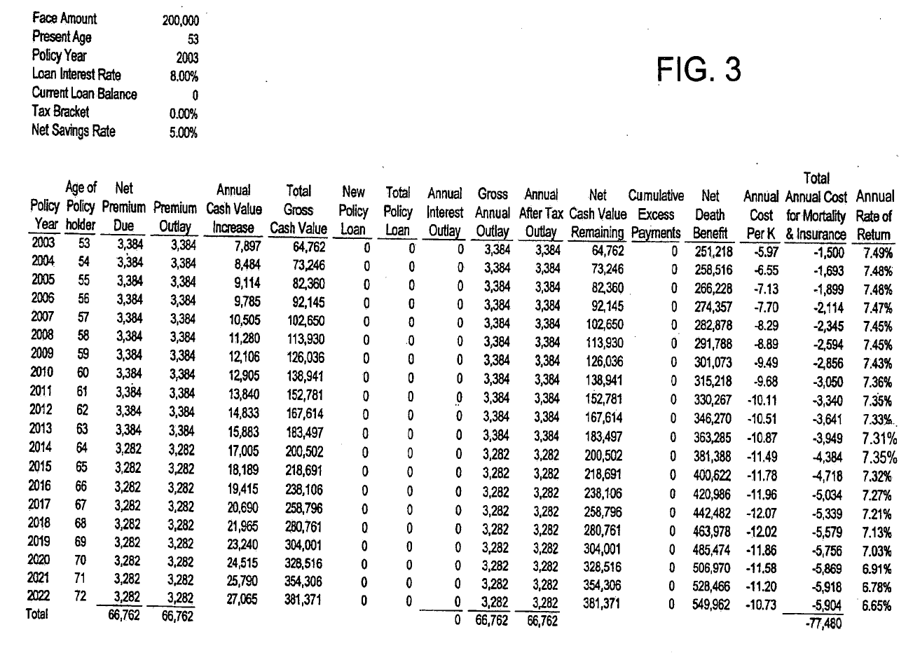

FIG. 3 is an example of a present insurance policy analysis report.

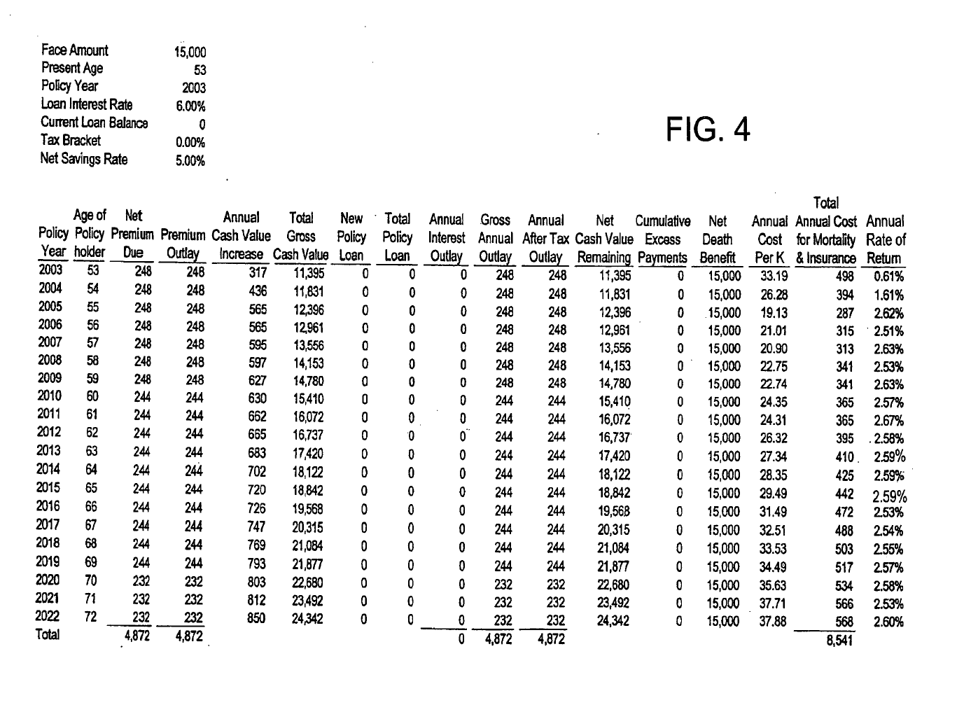

FIG. 4 is an example of a present insurance policy analysis report.

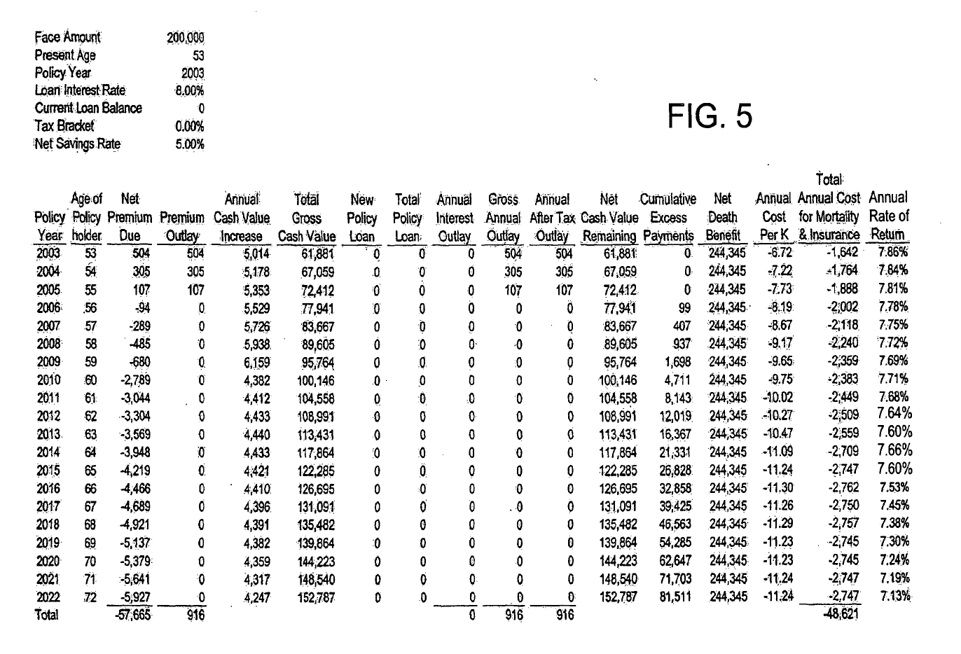

FIG. 5 is an example of a proposed change to a present policy.

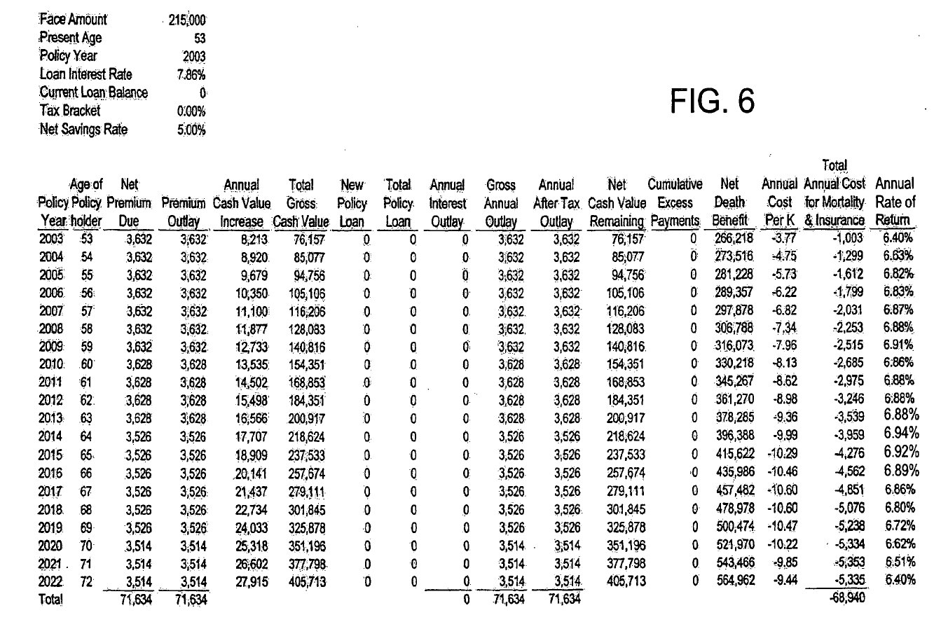

FIG. 6 is an example of a present consolidated insurance portfolio analysis report.

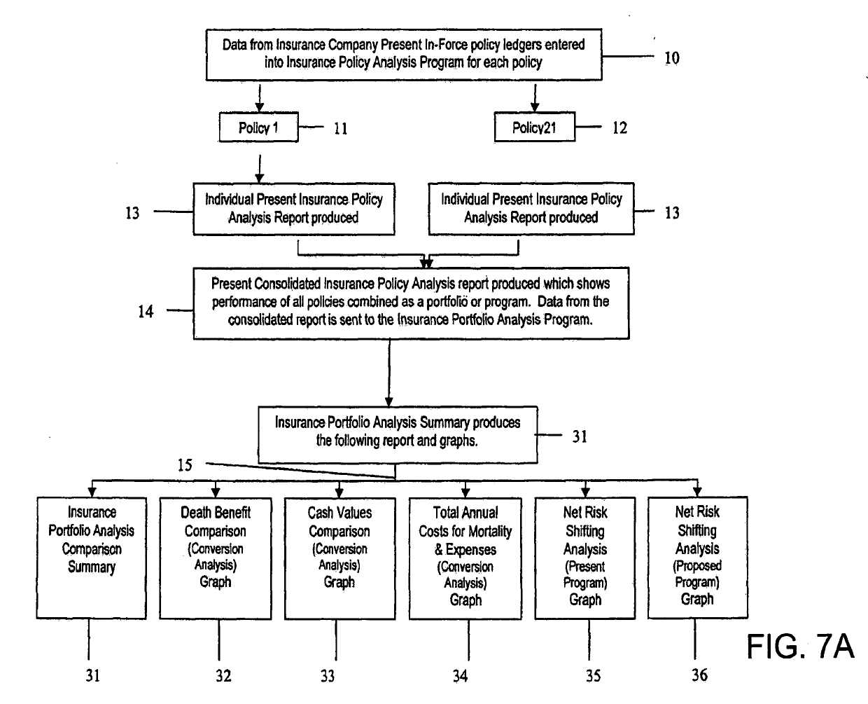

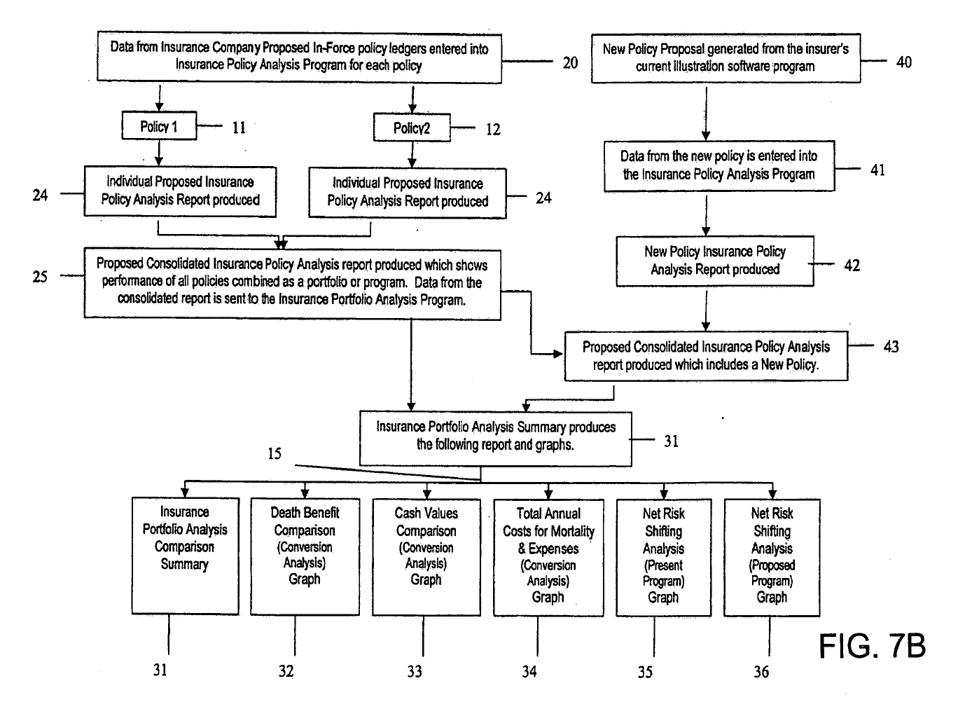

FIG. 7A is a flow chart of insurance portfolio analysis of present policies.

FIG. 7B is a flow chart of insurance portfolio analysis of present policies with a new policy added.

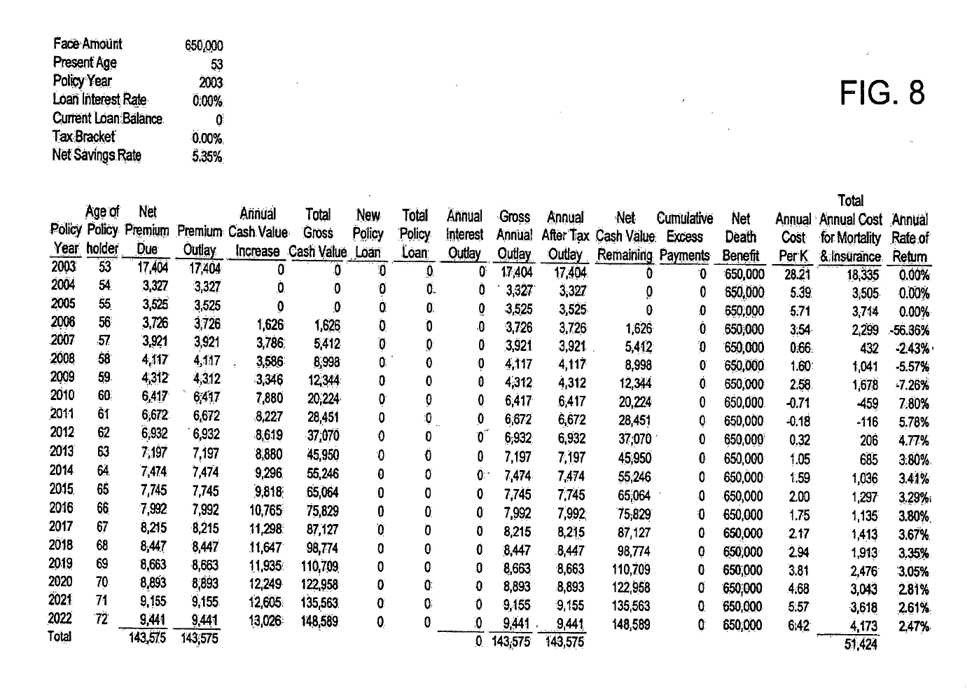

FIG. 8 is an example of an insurance policy analysis of a new proposed policy.

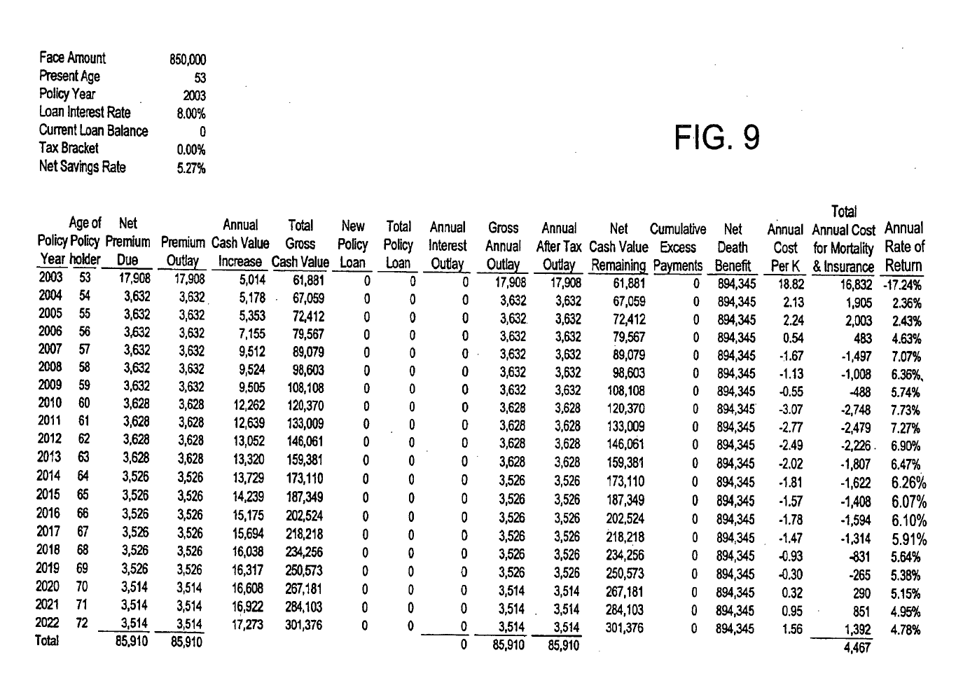

FIG. 9 is an example of a proposed consolidated ledger insurance portfolio analysis.

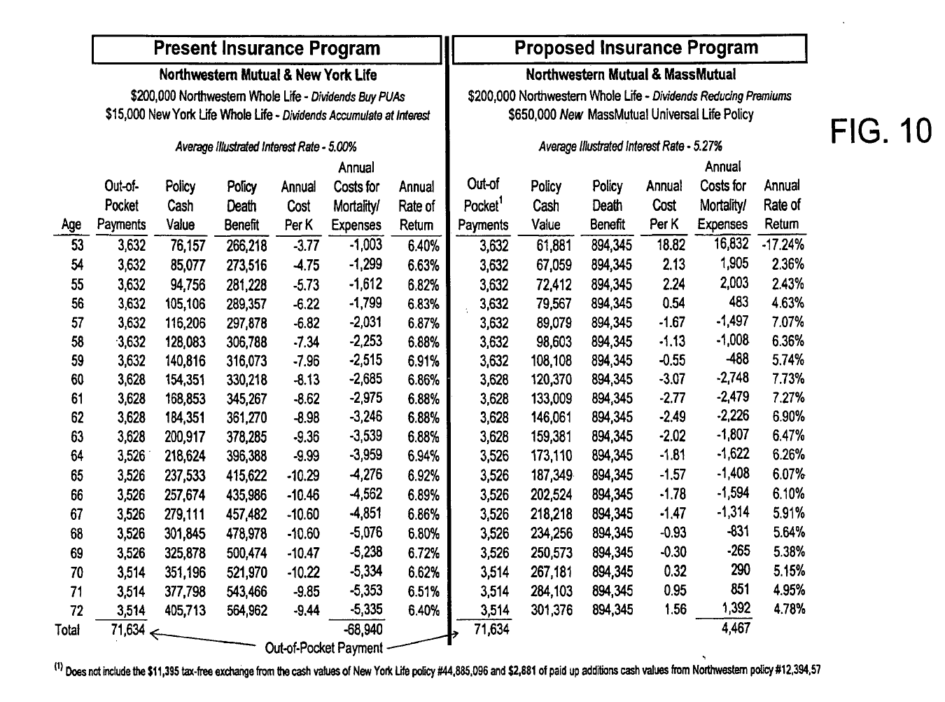

FIG. 10 is an example of an insurance portfolio analysis summary.

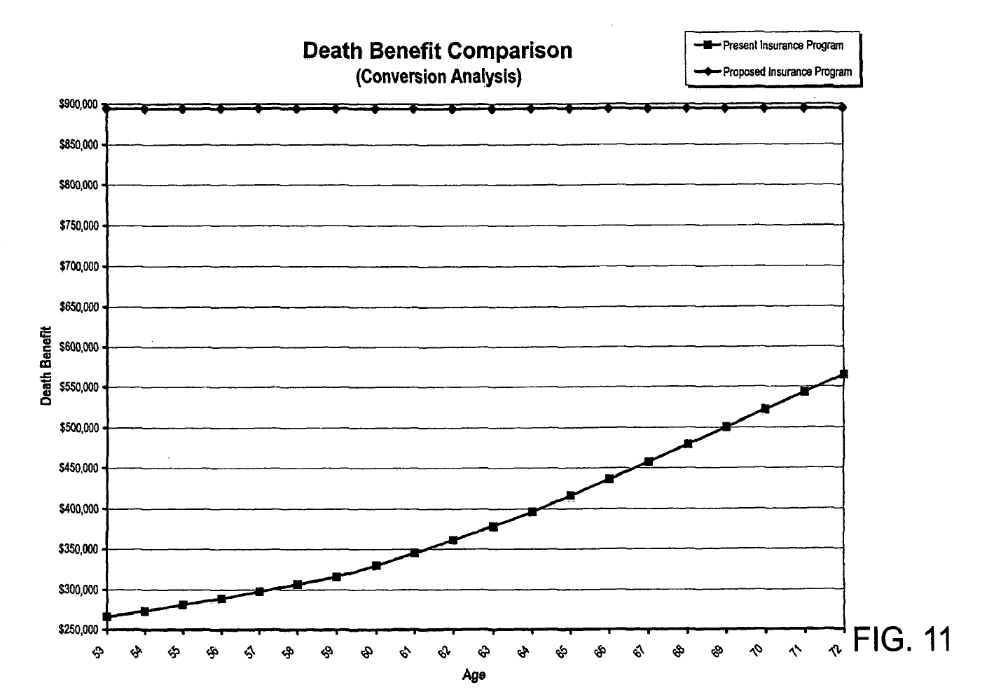

FIG. 11 is a death benefit comparison graph.

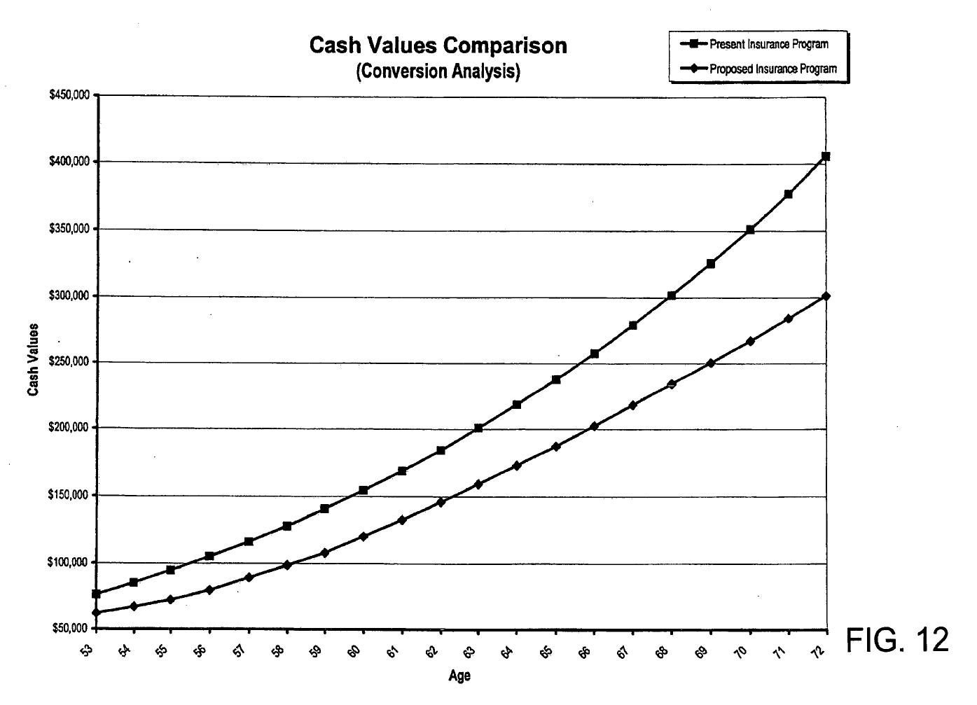

FIG. 12 is a cash value comparison graph.

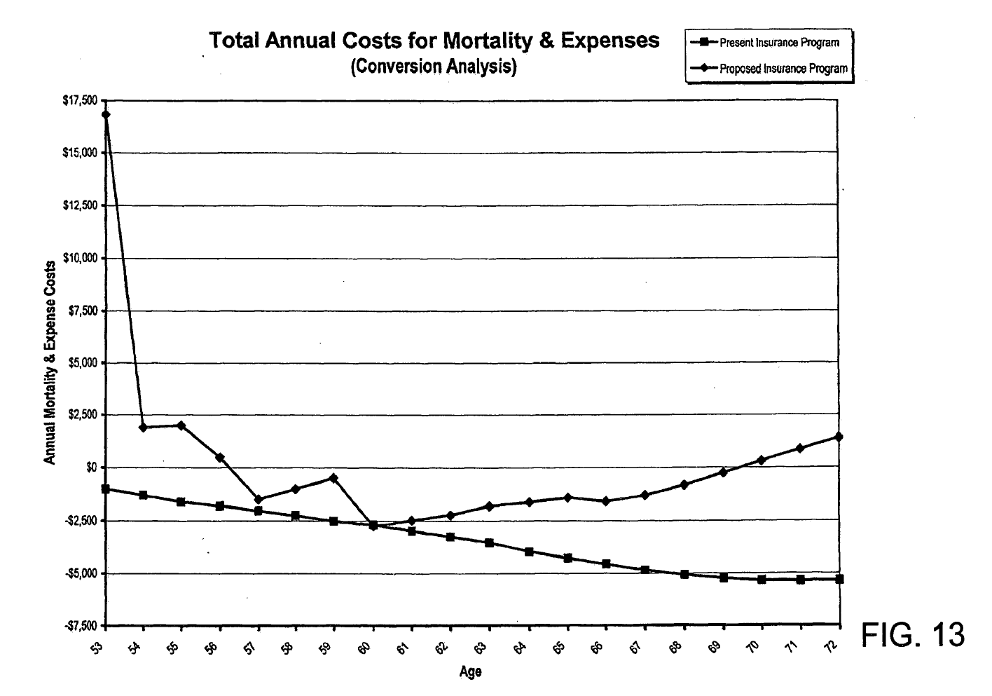

FIG. 13 is a total annual costs for mortality and expenses graph.

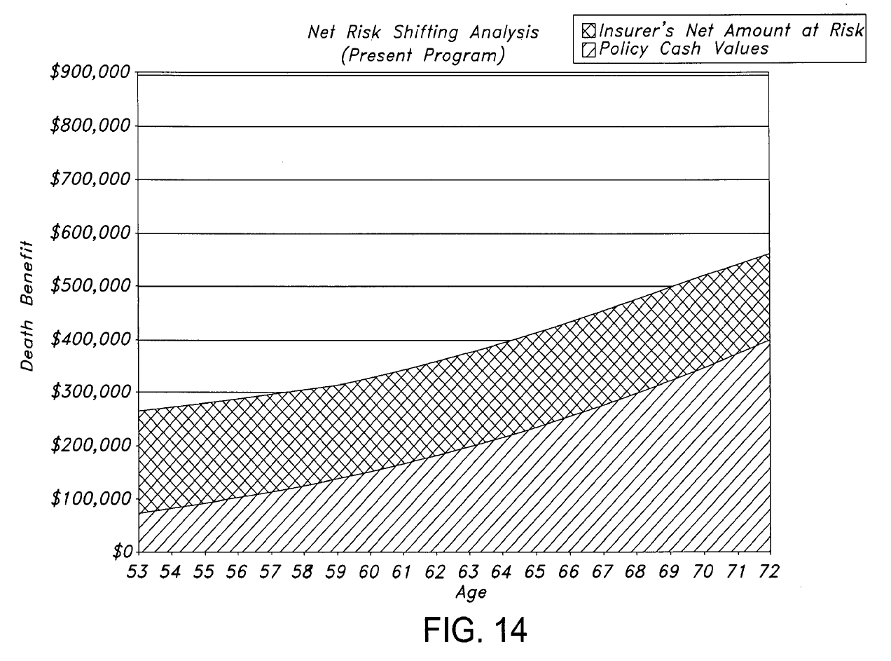

FIG. 14 is a net risk shifting analysis graph (present program).

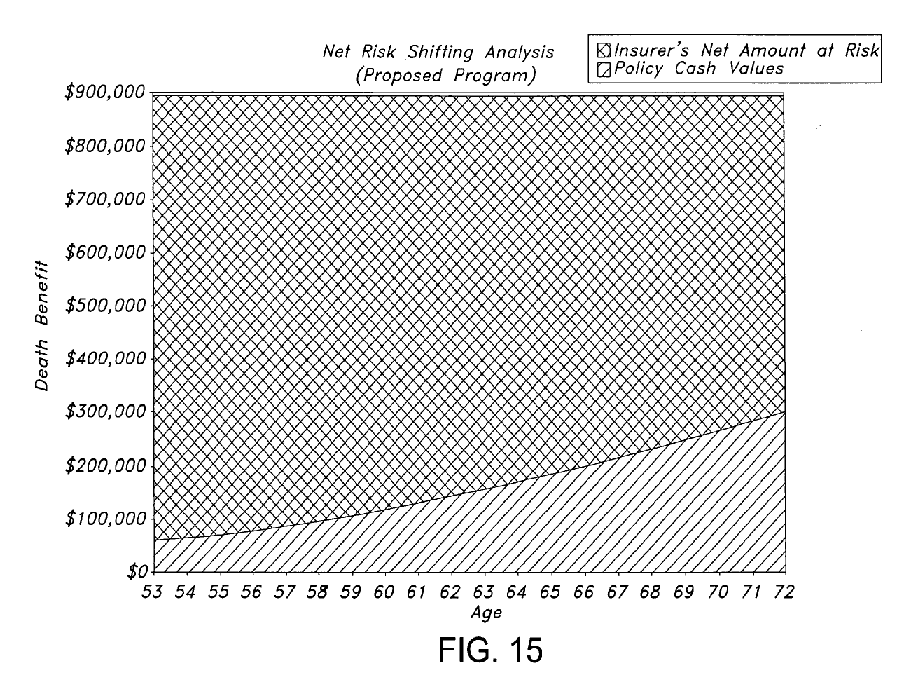

FIG. 15 is a net risk shifting analysis graph (proposed program).

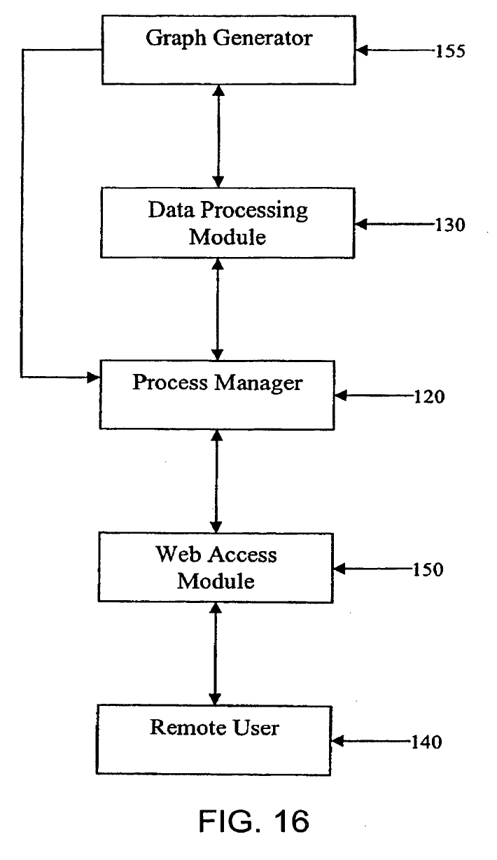

FIG. 16 is a block diagram of the insurance portfolio analysis system.

### DETAILED DESCRIPTION OF THE INVENTION

### Definitions

“Annual costs” is the combination of (1) after tax outlay, (2) after tax outlay×net savings rate and (3) beginning net cash value×net savings rate. The net savings rate is the insurer's illustrated interest rate or value of money.

“Annual yield” is the combination of (1) dividends in excess of premiums and (2) net cash value increase.

“Annual cost per K” is the difference between Costs and Yields divided by the Per Thousand Dollars of Death Benefit.

“Annual cost of mortality/expenses” is annual cost per k multiplied by the per thousand dollars of death benefit provided.

“Cumulative excess payment” is the premium payments that exceed the annual premium due and/or dividends in excess of premiums due invested at the annual illustrated interest rate on the insurer's in-force policy ledger.

“Annual rate of return” is the beginning net cash values plus net payments divided into the ending net cash values minus 1.

“In force policy ledgers” is an insurer's year-to-year summary of an in-force policy's projected performance based on the insurer's assumed expenses, mortality costs, earnings and in some instances potential policy lapses. Based on the type of policy, the in-force ledger shows the projected dividends, annual cash value increases, total cash value, policy loans, policy loan interest, dividend accumulation values, dividend paid-up-addition death benefit values, paid-up-addition cash values, base policy death benefit values, policy rider values (e.g. term riders), annual premium payments for the base policy and in some instances the cost of policy riders (e.g. term riders, waiver of premium, etc.).

“Insurance program” is one or more insurance policies of an insured.

“Internet” is the vast collection of inter-connected networks that all use the TCP/IP protocols and that evolved from the ARPANET of the late 60's and early 70's. The Internet now (July 1995) connects roughly 60,000 independent networks into a vast global internet.

“Out-of-Pocket Payments” is the sum of: a.) premiums due; b.) loan interest paid; c.) annual dividends received; d.) annual withdrawals from cash values and/or; e.) combinations of any of the above; and f.) partial combinations of any of the above to have a designated payment or withdrawal.

“Out-of-Pocket Payment Savings” is the difference between the present and proposed out-of-pocket payments invested at the insurer's average illustrated interest rate.

“Policy cash value” is the net cash value available which is the surrender cash values that include paid up addition cash values, dividend accumulations and/or any policy riders that accumulate cash.

“Policy death benefit” is the net death benefit payable.

“Web” is a system of Internet servers that uses HTTP to transfer specially formatted documents. The documents are formatted in a language called HTML (Hypertext Mark-up Language) that supports links to other documents, as well as graphics, audio, and video files. One can jump from one document to another simply by clicking on hyperlinks.

Now referring to FIG. 1, the insurance portfolio analysis process is shown for present policies. Data from insurance company present in-force policy ledgers are obtained and entered into the insurance policy analysis program (data required to analyze the insurance policy is set out in FIG. 2). The insurance policy analysis program converts data from insurer's in-force ledger to a standard comparable format. Data from insurance companies can be provided by any means, such as electronic or printed format. In the example shown in FIG. 1, two policies 11 and 12 are submitted for analysis; however, any number of policies can be analyzed. The data obtained from the present in-force policy ledger is processed to obtain a present insurance policy analysis report. The term processed means the data from the present in-force policy is extracted from the in-force ledger, to obtain the report shown in FIGS. 3 and 4. A present insurance policy analysis report is prepared for at least one present insurance policy 13. Examples of present insurance policy reports are shown in FIGS. 3 and 4. The present insurance policy report provides information a policy holder would need to know to evaluate a policy based on the insurer's illustrated values and interest/earnings rate. This data can include: policy year, age of policy holder, premium outlay, annual cash value increase, total gross/net cash value increase, total gross/net cash value, new policy loan, total policy loan, annual interest outlay, gross annual outlay, annual after tax outlay, net cash value remaining, cumulative excess payments, net death benefits, annual cost per K, total annual cost for mortality and expenses and annual rate of return.

The data is processed to prepare a present consolidated insurance portfolio analysis report 14 which shows performance of all policies combined as a portfolio program. This report is shown in FIG. 6. Data from the consolidated reports are formatted as the insurance portfolio analysis summary 31. This report is shown in FIG. 10. The term present insurance policy means that an insurance policy is in existence and it is owned by a policy holder. A present insurance policy can include proposed changes and then it would be a proposed present insurance policy.

A user, such as an insurance agent, can review the insurance portfolio analysis summary 31 and rebalance an insurance portfolio and evaluate the purchase of life insurance based on the financial data shown in fields such as: (1) policy death benefits; (2) net saving rate; (3) annual rate of return on policy values; (4) net cash value remains; (5) total annual cost for mortality and insurance; (6) present and proposed risk shifting (total policy death benefit in excess of policy cash values). The user then can, based on his or her judgment, designate proposed changes to the in-force policy ledgers for at least one present insurance policy.

The next step is to obtain in-force policy ledgers of present policies with proposed changes from the insurance company and enter the appropriate ledger data into the insurance policy analysis program for each policy 20. The appropriate policy data can be either manually entered by referencing the insurer's in-force policy ledger or entered from an electronic data file provided by the insurer (data required to analyze the proposed change in the existing policy is set out in FIG. 2). In the example shown in FIG. 1, only one policy is changed. The New York Life policy shown in FIG. 4 is tax-free exchanged while the Northwestern Mutual policy options shown in FIG. 3 are changed. A proposed insurance policy analysis 24 report is prepared. If two present policies are changed then a proposed consolidated insurance portfolio analysis report which shows performance of all policies combined is prepared 25.

Additionally, as shown in FIGS. 7A and 7B, an analysis can be conducted of the present policies with a new policy 40 added. A new proposed policy proposal 40 is generated from an insurer's current illustration software program, such as MassMutual's Prism software. Data from the new policy illustration is entered into the insurance policy analysis program 41. The required field as set out in FIG. 2. A proposed new policy insurance policy analysis 43 report is produced.

The proposed consolidated insurance portfolio analysis report is produced which includes the new policy 43. This report shows the performance of all policies (both present policies with proposed changes & new proposed policy) combined as a portfolio or program. This report may include some or all of the policies (e.g. one or both of the present policies may be performing poorly and it is proposed that the client do a tax-free 1035 exchange to purchase new insurance). The present consolidated insurance portfolio analysis report 14, the proposed consolidated insurance portfolio analysis 25 and the new proposed consolidated insurance policy analysis 43 are combined into the insurance portfolio analysis summary 31 as shown in FIG. 10. The summary shows the present insurance program versus the proposed insurance program in terms of: age, out-of-pocket payments, policy cash value, policy death benefit, annual cost per K, annual costs for mortality/expenses, and annual rate of return. In this way, an insurance program can be evaluated like an investment. The Insurance Portfolio Analysis Summary Program 15 takes the data from a variety of insurance policies and organizes the data into a variety of charts 32-36. Using these reports and charts, a remote user 140 (FIG. 16), such as an insurance agent, can propose changes to the existing insurance policies.

More specifically, graphs are prepared based on this summary that show death benefit comparison graph 32 (FIG. 11); cash values comparison 33 (FIG. 12); total annual costs for mortality/expenses 34 (FIG. 13); net risk shifting analysis of present program 35 (FIG. 14). The top curve shows the insurer's net amount at risk, while the bottom curve shows the policy cash value 5.

This chart (FIG. 14) can be compared to chart 36 (FIG. 15), which shows the risk shifting analysis of the proposed program. The top portion shows the insurer's net amount of risk, while bottom portion shows the policyholder's policy cash values. A comparison of FIG. 14 and FIG. 15 shows that the proposed program 25 focuses shifting the risk to the insurer—this shift of risk being beneficial to a policy holder. An insurance policy can be selected by a comparison of charts showing net risk of an insurer versus a policy owner for at least one present insurance policy. This method includes the step of obtaining data from an insurance company's present in-force policy ledgers for at least one present policy. It also includes the step of processing the data from an insurance company present in-force policy ledgers to prepare a present insurance policy analysis report for at least one present insurance policy. Another step is identifying changes to the in-force policy ledgers for at least one present insurance policy. Another step is obtaining in-force policy ledgers with proposed changes to the at least one present insurance policy. Finally, the last step is processing the data from the insurance company proposed insurance policy ledger from the at least one present policy to prepare a proposed consolidated insurance portfolio analysis report. The term “charting” means to use charts or figures to identify the insurer's net risk.

Now referring to FIG. 16, a flow chart of a computer system for preparing an insurance portfolio analysis summary is shown. The computer system includes a process manager 120 connected to a plurality of modules. More specifically, the process manager 120 is connected to a data processing module 130. In the data processing module 130 data obtained from remote user 140 via a web access module 150 is used to prepare a variety of insurance policy analysis reports. Additionally, a variety of graphs are also prepared 155 and delivered to the process manager 120 for delivery through web based module 150 to a remote user 140.

More specifically, at least one secure server for managing user sessions over the internet is provided. This secure server enables communication between the user browser and the secure server. Additionally, this system includes an insurance policy data presentation device for enabling presentation of the insurance policy data for at least one policy. Additionally, this system includes an insurance policy data server device for receiving insurance policy data for at least one policy. More specifically, the insurance policy data server device prepares a present consolidated insurance policy analysis report. Additionally, an insurance policy data server device for enabling presentations of a proposed insurance policy data for a proposed policy is included. Additionally, an insurance policy data server device for receiving the proposed insurance policy data for a proposed device is included. More specifically, the insurance policy data server prepares an insurance portfolio analysis comparison summary. Finally, this system includes an insurance policy data server device for providing the summary to the user.

This computer system can be web based through a web access module 150. The web based insurance portfolio analysis system allows a user 140 to receive an insurance portfolio analysis over the internet. The user 140 uses a client browser application located at a user work station to communicate with the insurance portfolio analysis system. In an alternative embodiment, the reports and graphs can be delivered via email to the remote user 140.

In another embodiment of this invention, the method can be used to select marketable insurance policies (MIP) for sale to the secondary market for insurance policies. The purchaser's of marketable insurance policies are not only high net worth individuals, but also institutional investors, such as mutual funds and provident funds looking for high yield instruments in view of low interest rates. More specifically, data would be obtained from insurance company present in-force ledgers for a plurality of insurance policies. Present insurance policy analysis reports can be prepared for the plurality of policies. Based on these reports, graphs can be generated of: death benefit, cash value, total annual cost for mortality/expenses, and net risk shifting. These graphs can be made available to a remote user, such as by accessing a secure web site, and the remote user can use the report and graphs to select those policies which are saleable on a secondary market. An example of an insurance policy that is saleable on a secondary market is typically one with significantly low cash value, moderate required premiums payments to projected mortality and/or one in which the risk can be significantly shifted to the insurer.

Although the foregoing invention has been described in some detail by way of illustration and example for purposes of clarity of understanding, it will be obvious that certain changes and modifications can be made which are within the full scope of the invention. Further technical aspects of the computer system and the method of the invention are the subject matter of further dependent claims.

I claim:

1. A method for insurance portfolio analysis comprising:
(a) obtaining data from an insurance company's present in-force policy ledgers for at least one present policy;
(b) processing said data from an insurance company present in-force policy ledgers to prepare a present insurance policy analysis report for at least one present insurance policy;
(c) designating proposed changes to said in-force policy ledgers for at least one present insurance policy;
(d) obtaining in-force policy ledgers with proposed changes to said at least one present insurance policy;
(e) processing said data from said insurance company proposed insurance policy ledgers for said at least one present policy to prepare a proposed insurance policy analysis report; and
(f) combining the present insurance policy report analysis report and the present proposed insurance policy analysis report to provide an insurance portfolio analysis summary.

2. The method of claim 1 wherein a present consolidated insurance policy analysis report is prepared for at least two present policies.

3. The method of claim 1 wherein said insurance portfolio analysis summary includes a death benefit comparison graph.

4. The method of claim 1 wherein said insurance portfolio analysis summary includes a cash value comparison graph.

5. The method of claim 1 wherein said insurance portfolio analysis summary includes a total annual costs for mortality and expenses graph.

6. The method of claim 1 wherein said insurance portfolio analysis summary includes a net risk shifting analysis graph for at least one present insurance policy.

7. The method of claim 1 wherein said insurance portfolio analysis summary includes a net risk shifting analysis graph for at least one present proposed insurance policy.

8. The method of claim 1 further comprising the step of:
(a) designating at least one new proposed policy;
(b) processing data from said at least one new proposed policy to prepare a new policy analysis report; and
(c) combining the present insurance policy analysis report, the present proposed insurance policy analysis report and the new policy analysis report to provide an insurance portfolio analysis summary.

9. A method to select an insurance policy based on a comparison of net risk of an insurer versus a policy owner for at least one present insurance policy comprising:
(a) charting an insurer's net amount at risk for a specified death benefit at a specified age of an insured for at least one present insurance policy;
(b) charting the policy cash value for a specified death benefit at a specified age of an insured for at least one present insurance policy; and
(c) identifying at least one insurance policy where the insurer's net risk is greater than the policy cash value at a specified age of an insured.
